(19) United States
(12) Patent Application Publication
(10) Pub. No.: US 2004/0056542 A1
(43) Pub. Date: Mar. 25, 2004

(54) Rotor for an electrical rotating machine

(75) Inventors: Juergen Baer, Maegenwil (CH); Joachim Bremer, Benglen (CH); Wolfgang Mesters, Zuerich (CH); Ulf Christian Mueller, Kirchdorf (CH)

Correspondence Address: BURNS DOANE SWECKER & MATHIS L L P, POST OFFICE BOX 1404, ALEXANDRIA, VA, 22313-1404, US

(73) Assignee: ALSTOM ( Switzerland) LTD.

(21) Appl. No.: 10/665,559

(22) Filed: Sep. 22, 2003

Related U.S. Application Data
(63) Continuation of application No. 09/988,405, filed on Nov. 19, 2001.

(30) Foreign Application Priority Data
Nov. 30, 2000 (DE) 100 59 387.9

(51) Int. Cl. H02K 9/00

(52) U.S. Cl. 310/58

(57) ABSTRACT

The invention relates to a rotor for an electrical rotating machine, e.g., a turbo generator. The rotor has a rotor winding that is provided with several sectors positioned next to each other in circumferential direction. In each sector, several conductor bars are stacked on top of each other in radial direction. The conductor bars extend parallel to the longitudinal rotor axis. Each of the sectors has an axial ventilation channel and several radial ventilation openings communicating with said ventilation channel. In relation to the conductor bars, the ventilation channel is positioned radially inside and extends parallel to the longitudinal rotor axis. The ventilation openings are spaced apart from each other in axial direction and extend radially through the conductor bars. In order to improve the production of the rotor, the ventilation openings in the conductor bars are formed by circular holes that, in the case of the stacked conductor bars of a sector, are positioned so as to be radially aligned with each other.

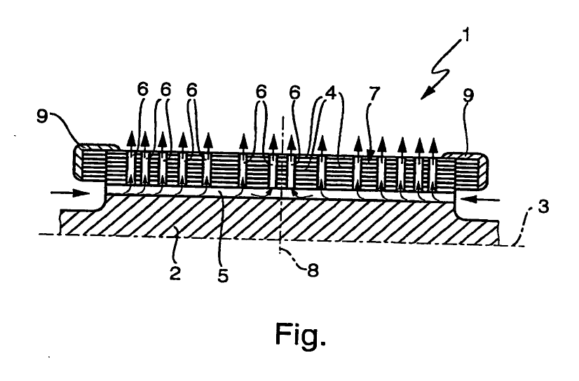

This application is related and claims priority under 35 U.S.C. § 119 to German Patent Application No. 100 59 387.9, filed Nov. 30, 2000, the entire contents of which are incorporated by reference herein. In addition, this application is a continuation of U.S. patent application Ser. No. 09/988,405 filed on Nov. 19, 2001, upon which Applicants rely for the benefits provided in 35 U.S.C. §120, the entire contents of which are incorporated by reference herein.

### FIELD OF THE INVENTION

The invention relates to a rotor for an electrical rotating machine, for example a turbo generator. The invention also relates to a method for producing such a rotor and a device for performing this method, as well as the use of such a device for performing the method.

### BACKGROUND OF THE INVENTION

JP-A 0 900 95 42 (abstract) discloses such a rotor provided with a rotor winding that is equipped with several sectors positioned next to each other in circumferential direction, in each of which sectors several conductor bars are stacked on top of each other in radial direction. Each of these sectors hereby has an axial ventilation channel and several radial ventilation openings communicating with the axial ventilation channel. In relation to the conductor bars, this ventilation channel is positioned on the rotor radially inside and extends parallel to the longitudinal rotor axis. The ventilation openings are spaced apart from each other in axial direction and extend radially through the conductor bars. The ventilation openings are hereby constructed as slits or long holes and extend in axial direction.

Together with the ventilation openings connected to it, such a ventilation channel is used to realize a cooling of the rotor or rotor winding, in which the cooling air, supplied axially outside into the ventilation channel, flows through the ventilation channel and ventilation opening. In order to improve the cooling effect, it is suggested in the case of the known rotor to make the axial length of the slits or long holes that form the ventilation openings larger within the axially inner section of the rotor than in the axially outer sections.

A rotor of the initially mentioned type is also known from JP-A 0 831 75 80 (abstract). In the rotor disclosed there, the air holes are also formed by slits or long holes extending in axial direction. In order to improve the cooling of the rotor or rotor winding for this rotor, a first alternative suggests selecting the axial length of the slots or long holes in an axially inner section of the rotor smaller than in the axially outer sections. As a second alternative, it is suggested that the axial length of the slits or long holes is kept constant, and instead the axial spaces between adjoining slits or long holes in an axially inner section of the rotor is made larger than in the axially outer sections.

The production of the known rotors is very expensive, since the production of the long holes or slits in the individual conductor bars requires high expenditures in terms of equipment and time. In addition, the need for a further improvement of the cooling effect for the rotor or rotor winding remains even for the known rotors.

### SUMMARY OF THE INVENTION

The present invention deals with the objective of disclosing possibilities for a rotor of the initially mentioned type that would permit a relatively economical production of the rotor. In addition, the cooling of the rotor or rotor winding should be improved.

The invention is based on the general thought of constructing the radially extending ventilation openings in the conductor bars by means of circular holes. This measure on the one hand ensures that the rotor can be produced economically since circular holes can be manufactured especially easily and especially quickly into the conductor bars. The manufacturing of such holes also is suited particularly well for an automatically occurring manufacturing process. On the other hand, the application of circular holes in place of slits or long holes permits an improvement of the cooling effect for the rotor or rotor winding, since several circular holes positioned axially next to each other may have a larger area than a corresponding long hole. As a result, it is possible to achieve a better heat exchange between the cooling air and the conductors to be cooled with several holes positioned along an axial section with a length X than with a long hole having the axial length X.

An especially simple production of the ventilation openings is achieved if all holes in all ventilation openings in all sectors provided with ventilation openings have the same diameter. This uniformity therefore makes it principally possible to produce all holes with only a single tool.

The cooling effect for the rotor or rotor winding can be increased in a special embodiment in that the ventilation openings are positioned so that the axial sections of adjoining ventilation openings increase from axially outside to axially inside. This embodiment hereby uses the understanding that an aerodynamic deflection resistance must be overcome in order to radially deflect the flow flowing axially inside the ventilation channel into the ventilation openings where the flow flows radially. This defection resistance is hereby greater on the axial outside than on the axial inside, since the axial cooling air flow in the ventilation openings positioned axially further outside has a relatively high flow velocity. In the ventilation openings positioned axially further inside, the flow velocity of the cooling airflow is reduced as a result of previous off-flows, so that the deflection resistance is smaller there.

In comparison to a traditional method in which long holes or slits must be cut, the method according to the invention can be performed substantially quicker, since only circular holes must be manufactured into the conductor bars. Since the method according to the invention is performed more quickly than a traditional one, the production costs for the conductor bars and therefore for the rotor can be reduced.

It is hereby suggested that the circular holes are made automatically at the sites intended for the ventilation openings by means of a corresponding drilling device. Since the device according to the invention works with a drilling device that according to the invention produces circular holes, it is able to work more quickly than a device for producing slit-shaped openings that works, for example, with a cutting device or with a combined drilling and cutting device. Accordingly, the device according to the invention permits a reduction of the manufacturing costs for the conductor bars and therefore for the rotor.

The suggested use also ensures shorter production times for the conductor bars, and therefore reduced production costs for the conductor bars and consequently for the rotor.

### BRIEF DESCRIPTION OF THE DRAWING

The drawing shows a preferred embodiment of the invention, which is described in more detail in the following description. The only FIGURE shows an axial section through a half of a rotor according to the invention.

### DETAILED DESCRIPTION OF THE PREFERRED EMBODIMENT

According to the FIGURE, a rotor 1 is provided with a central rotor body or rotor wheel 2 that rotates about its longitudinal axis 3 when the rotor 1 is installed in a corresponding electrical rotating machine forming, for example, a turbo generator.

The rotor 1 has a rotor winding 7 at its rotor body 2. The rotor 1 or its rotor winding 7 is divided along its circumference into several sectors positioned next to each other in circumferential direction. The longitudinal section shown in the FIGURE passes through one of these sectors. In each of these sectors, several conductor bars 4 are stacked on top of each other in radial direction. These conductor bars 4, which, for example, may be formed by copper bars, extend parallel to the longitudinal rotor axis 3 and are electrically insulated relative to each other in the usual manner.

In each sector, the rotor 1 has a ventilation channel 5 that extends in axial direction of the rotor wheel 2. This ventilation channel 5 is positioned in relation to the conductor bars 4 radially inside on the rotor wheel 2. Several radial ventilation openings 6 that extend in radial direction through the conductor bars 4 communicate with this ventilation channel 5. When operating the rotor 1 in an electrical rotating machine, these air holes 6 cool the conductor bars 4 and therefore the rotor winding 7 and ultimately the rotor 1. For this purpose, the ventilation channel 5 is supplied at both axial ends with cooling air that is then distributed over the individual ventilation openings 6, flows through the conductor bars 4, and then exits from the rotor winding 7.

According to the invention, all ventilation openings 6 are formed by circular holes constructed in the individual conductor bars 4. In the assembled rotor 1, the selected positioning of these holes along the conductor bars 4 the ventilation openings 6 may be formed by the fact that the holes of the stacked conductor bars 4 are positioned so as to extend in alignment radially towards each other.

In the preferred embodiment shown in the FIGURE, the axial spaces between adjoining ventilation openings 6 decrease axially towards the outside starting from a rotor center 8, in the immediate proximity of which the first two ventilation openings are positioned. In this way, a relatively homogeneous distribution of the cooling airflow along the axial length of the rotor 1 results. This results in an improvement of the cooling effect of the rotor 1 or of the rotor winding 7. This measure makes it possible to substantially increase the useful life as well as the electrically generated power of the rotor 1.

The FIGURE also shows one each inductor cap 9 at the axial ends of the rotor body 2. It is clear that the rotor 1 may be provided radially outside in the usual way with a wedge used to fix the conductor bars 4 on the rotor body 2. In corresponding manner, a suitable insulation also may be provided radially between this wedge.

In order to cool the rotor 1 or to cool the rotor winding 7, all sectors of the rotor 1 or rotor winding 7 are provided with such a cooling channel 5 or such cooling openings 6.

The production of the rotor 1 is simplified in a special way if all holes to be provided in the conductor bars 4 in order to form the ventilation openings 6 have the same diameter.

1. A rotor comprising:
a rotor winding having a plurality of sectors positioned next to each other in a circumferential direction, in each of which sectors a plurality of conductor bars extending parallel to a longitudinal rotor axis are stacked on top of each other in a radial direction, whereby each of the sectors is provided with an axial ventilation channel and a plurality of radial ventilation openings communicating with said axial ventilation channel, whereby the ventilation channel is positioned in relation to the conductor bars radially inside and extends parallel to the longitudinal rotor axis, and whereby the ventilation openings are spaced apart from each other in axial direction and extend through the conductor bars in radial direction, characterized in that all ventilation openings in the conductor bars are formed by circular holes having the same diameter, said circular holes being positioned on the stacked conductor bars in all sectors provided with air holes so as to be radially aligned with each other.

2. The rotor as claimed in claim 1, wherein the ventilation openings are positioned so that the axial spaces between adjoining ventilation openings along the rotor increase from axially outside to axially inside.

3. A method for producing a rotor as claimed in claim 1, wherein, for the formation of the ventilation openings, circular holes positioned so that the holes are radially aligned when the conductor bars are stacked on each other and in this way form the ventilation openings are made into the corresponding conductor bars.

4. A device for performing the method as claimed in claim 3, wherein a holding device is provided that fixes the conductor bar to be processed, and that a drilling device is provided that automatically produces holes at the sites intended for the ventilation openings.
